(19) United States
(12) Patent Application Publication
(10) Pub. No.: US 2011/0275740 A1
(43) Pub. Date: Nov. 10, 2011

(54) Nanocomposite Materials and Method of Making Same by Nano-Precipitation

(75) Inventors: Patrice Lucas, Montreal (CA); Francois Ganachaud, Montpellier (FR); Julien Aubry, Montpellier (FR); Malvina Vaysse, Saint Martin de Riberac (FR)

(73) Assignees: NANOLEDGE INC., Boucherville, QC (CA); ECOLE NATIONALE SUPERIEURE DE CHIMIE DE MONTPELIER, MONPELIER (FR); CENTRE NATIONAL DE LA RECHERCHE SCIENTIFIQUE (C.N.R.S.), Paris (FR)

(21) Appl. No.: 13/122,922

(22) PCT Filed: Oct. 7, 2009
(86) PCT No.: PCT/CA2009/001423

§ 371 Date: Aug. 1, 2011

(30) Foreign Application Priority Data
Oct. 7, 2008 (FR) 0856795

(51) Int. Cl. C08L 63/00; C08K 5/07; B82Y 30/00

(52) U.S. Cl. 523/402; 524/364; 977/742

(57) ABSTRACT

The invention relates to a method for preparing submicronic particles of a thermoplastic polymer encapsulating nanoparticles, said submicronic particles being obtained by nanoprecipitation. The invention also relates to submicronic particles of a polymer encapsulating nanoparticles obtained by said method, and to the use of submicronic particles for making materials reinforced by nanoparticles.

### FIELD OF THE INVENTION

This invention relates, in general, to materials reinforced by nanoparticles. This invention also relates to submicronic particles made by dispersing carbon nanotubes into a polymer matrix using nanoprecipitation.

### STATE OF THE ART

Nanoparticles normally have at least two dimensions greater than or equal to one nanometer and less than 100 nanometers. For example, carbon nanotubes have a tube shape and a graphene structure. The properties of carbon nanotubes have already been described exhaustively (R. Saito, G. Dresselhaus, M. S. Dresselhaus; Physical Properties of Carbon Nanotubes, Imperial College Press, London U.K. 1998; J.-B. Donnet, T. K. Wang, J. C. M. Peng, S. Rebouillat [ed.], Carbon Fibers, Marcel Dekker N.Y; USA 1998). The state of the art lists two main types of carbon nanotubes: single-walled carbon nanotubes (SWNTs) and multi-walled carbon nanotubes (MWNTs). The diameter of nanotubes varies between approximately 0.4 and more than 3 nm for SWNTs and from approximately 1.4 to more than 100 nm for MWNTs (Z. K. Tang et al., Science 292, 2462 (2001); R. G. Ding, G. Q. Lu, Z. F. Yan, M. A. Wilson, J. Nanosci. Nanotechnol. 1, 7 (2001)). Some research has shown that incorporating carbon nanotubes into plastic materials can improve their mechanical and electrical properties (M. J. Biercuk et al. Appl. Phys. Lett. 80, 2767 (2002); D. Qian, E. C. Dickey, R. Andrews, T. Randell, Appl. Phys. Lett. 76, 2868 (2000)).

One application of nanoparticles is to add them to a polymer matrix as additives or reinforcing agents. However, the transfer of mechanical and electrical properties from the nanoparticles to the polymer matrices requires a good dispersion of the nanoparticles. The more homogeneous the nanoparticle dispersion, the better the mechanical properties of the resulting nanocomposite material.

One preparation method for nanocomposite materials which has been described exhaustively is “latex” technology. This technique consists of first creating an aqueous phase dispersion of nanoparticles using a surfactant. Then, a latex polymer is made by stabilizing a polymer emulsion, which is also in an aqueous phase, using a surfactant. After elimination of the solvent using a variety of techniques, a nanocomposite material is obtained from these two aqueous phases.

The preparation of a multi-walled carbon nanotubes and polystyrene nanocomposite is based on SDS stabilized polystyrene latex and an aqueous dispersion of carbon nanotubes as described by Yu et al. (J. Yu, K. Lu, E. Sourty, N. Grossiord, C. E. Koning, J. Loos; Characterization of Conductive Multiwall Carbon Nanotube/Polystyrene Composites Prepared by Latex Technology, Carbon, 45, 2897-2903 (2007)). After freezing the mixture in liquid nitrogen and eliminating water by lyophilization, the authors obtained a nanocomposite material with electrical conductivity.

A nanocomposite material of multi-walled carbon nanotubes in poly(styrene-cobutyl acrylate), obtained by a similar procedure, was described by Dufresne et al. (A. Dufresne, M. Paillet, J. L. Putaux, R. Canet, F. Carmona, P. Delhaes, S. Cui; Processing and Characterization of Carbon Nanotube/Poly(styrene-cobutyl acrylate) Nanocomposites, Journal of Material Science, 37, 3915-3923 (2002)).

The nanocomposite material obtained presented improved mechanical properties compared to a virgin copolymer.

Preparation of a nanocomposite material using a relatively similar process was described by Zhang et al. (W. Zhang, M. J. Yang; Dispersion of Carbon Nanotubes in Polymer Matrix by in-situ Emulsion Polymerization, Journal of Material Science, 39, 4921-4922 (2004)). The main difference in this process compared to the process described by Yu et al. is that instead of mixing the dispersed carbon nanotubes with a latex polymer, they combined the dispersed carbon nanotubes with the monomer dispersion stabilized by a surfactant and they used in-situ emulsion polymerization to obtain latex.

The “coagulation” technology described by Winey et al. (F. Du, J. E. Fischer, K. I. Winey; Coagulation Method for Preparing Single-Walled Carbon Nanotube/Poly(methyl methacrylate) Composites and Their Modulus, Electrical Conductivity, and Thermal Stability, Journal of Polymer Science: Part B: Polymer Physics, 41, 3333-3338 (2003); K. I. Winey, F. Du, R. Haggenmueller; patent application US 2006/0036018 A1; K. I. Winey, F. Du, R. Haggenmueller, T. Kashiwagi; patent application US 2006/0036016 A1 (2004)) for creating nanocomposite materials. The first step is to disperse the carbon nanotubes in a polymer solution. The second step is the non-solvent precipitation of the aforementioned mixture. The carbon nanotubes are isolated in the polymer precipitation.

Patent application PCT WO 2006/007393 A1 by North Carolina State University describes a method based on a process similar to coagulation to create polymer microrods with an increased average aspect ratio (usually above 5). The inventors use the pouring of a polymer dissolved into a non-solvent to form microspheres

which are elongated into microrods by controlling the relative viscosities of both phases and by introducing a controlled shear rate to the medium. Filler could be added to the polymer that is initially dissolved before continuing with the pouring and the forming of charged microrods.

Nanoprecipitation is a particle preparation method which uses a simple process. This process is already used in the pharmaceutical field to prepare active principles such as carotenoids or retinoids (U.S. Pat. No. 4,522,743) in fine dry powder form (less than 0.5 μm) or in the field of ink, to obtain pigments in similar forms (U.S. Pat. No. 5,624,467), both without the use of surfactant agents. This method has also been used to obtain poly(lactic acid-co-ethylene oxide) nanoparticles without the use of surfactant agents (U.S. Pat. No. 5,766,635).

Nanoprecipitation is described in: Vitale and Katz, Langmuir, 2003, 19, 4105-4110. The authors named the phenomenon the “Ouzo effect”. They produced the first graph of the nanoprecipitation phase and proposed an explanation of the phenomenon as a process of liquid-liquid nucleation. The phenomenon happens when a mixture of a water miscible solvent and a hydrophobic oil is added to water—and then more water is added—generating small stable droplets which are formed even in the absence of surfactant (Ganachaud and Katz, ChemPhysChem, 2005, 6, 205-219). Emulsions without surfactant are called “metastable” as they remain stable for many hours or many days depending on the composition of the system. Nanoprecipitation can also take place when using two organic solvents.

When a solution containing oil (e.g. a thermoplastic polymer) is added to water, the dispersal of the water in the organic solvent results in oversaturation of the oil and nucleation of droplets. The oil is dispersed

in the nearest droplets which has the effect of reducing the oversaturation and stops the nucleation phenomenon.

### STATEMENT OF INVENTION

This invention concerns the preparation of nanocomposite materials.

This invention specifically relates to a method for preparing submicronic particles of a thermoplastic polymer encapsulating nanoparticles.

This invention concerns specifically the manufacture of submicronic spheres of a thermoplastic polymer encapsulating nanoparticles, using a process which results in a nanocomposite material in the form of a fine powder in which the nanofiller is in a non-agglomerated state and well dispersed.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is a dissolved into a second solvent; nanoprecipitation is induced by pouring the polymer solution into the nanoparticle dispersion.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is a dissolved into a second solvent;

nanoprecipitation is induced by pouring the polymer solution into the nanoparticle dispersion. In one embodiment, the first and second solvent are at least partially miscible and the polymer is insoluble in a solution of the first and the second solvent in the final proportions.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the polymer solution into the nanoparticle dispersion. In one embodiment, the dispersion is an aqueous dispersion.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the polymer solution into the nanoparticle dispersion. In one embodiment, the nanofiller is in a non-agglomerated state.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is a dissolved into a second solvent; nanoprecipitation is induced by pouring the polymer solution into

nanoparticle dispersion. In one embodiment, the polymer is a thermoplastic polymer.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the polymer solution into the nanoparticle dispersion. In one embodiment, the nanoparticles are carbon nanotubes.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the polymer solution into the nanoparticle dispersion. In one embodiment, the first and second solvent are at least partially miscible and the polymer is insoluble in a solution of the first and the second solvent in the final proportions. In one embodiment, the nanofiller is in a non-agglomerated state.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the polymer solution into the nanoparticle dispersion. In one embodiment, the first solvent and the

second solvent are at least partially miscible and the polymer is insoluble in a solution of the first and the second solvent in the final proportions. In one embodiment, the polymer is a thermoplastic polymer.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the polymer solution into the nanoparticle dispersion. In one embodiment, the first and second solvent are at least partially miscible and the polymer is insoluble in a solution of the first and the second solvent in the final proportions. In one embodiment, the nanoparticles are carbon nanotubes.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the first solvent and the

second solvent are at least partially miscible and the polymer is insoluble in a solution of the first and the second solvent in the final proportions.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the dispersion is an aqueous dispersion.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the nanofiller is in a non-agglomerated state.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the polymer is a thermoplastic polymer.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the nanoparticles are carbon nanotubes.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the first and second solvent are at least partially miscible and the polymer is insoluble in a solution of the first and the second solvent in the final proportions. In one embodiment, the nanofiller is in a non-agglomerated state.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the first and second solvent are at least partially miscible and the polymer is insoluble in a solution of the first and the second solvent in the final proportions. In one embodiment, the polymer is a thermoplastic polymer.

In one embodiment, this invention concerns a process for the manufacture of submicronic particles of polymer encapsulating nanoparticles. These particles are obtained by nanoprecipitation, a process which involves the dispersion of nanoparticles into a first solvent, this first solvent being a non-solvent for the polymer; the polymer is dissolved into a second solvent; nanoprecipitation is induced by pouring the nanoparticle dispersion into the polymer solution. In one embodiment, the first and second solvent are at least partially miscible and the polymer is insoluble in a solution of the first and the second solvent in the final proportions. In one embodiment, the nanoparticles are carbon nanotubes.

In one embodiment of this invention, the process results in nanocomposite beads, more specifically submicronic thermoplastic polymer beads encapsulating carbon nanotubes.

In one embodiment of this invention, the process results in nanocomposite beads encapsulating carbon nanotubes which can be incorporated into a polymer matrix.

In one embodiment of this invention, the manufacturing process for nanocomposite material does not require specific equipment such as an extruder or mechanical mixer.

### DESCRIPTION OF THE FIGURES

FIG. 1 is a graph of the phases to obtain submicronic spherical thermoplastic polymer particles encapsulating nanoparticles.

FIG. 2 is a photograph obtained by scanning electron microscopy of the submicronic thermoplastic polymer particles encapsulating carbon nanotubes obtained by nanoprecipitation in one embodiment of this invention.

FIG. 3 is graph of the phases to obtain submicronic polymethyl methacrylate (PMMA) particles encapsulating carbon nanotubes. The initial dispersion of the carbon nanotubes in the aqueous phase before nanoprecipitation is stabilized by sodium chlorate.

FIG. 4 is a graph of the phases to obtain submicronic PMMA particles encapsulating carbon nanotubes. The initial dispersion of the carbon nanotubes in the aqueous phase before nanoprecipitation is stabilized by sodium dodecylbenzenesulfonate.

FIG. 5 is a photograph of an emulsion of submicronic polymethacrylate PMMA particles encapsulating carbon nanotubes obtained by nanoprecipitation: (a) before ultra-centrifugation; and (b) after ultracentrifugation.

FIG. 6 is a photograph obtained by transmission electron microscopy of a carbon nanotube dispersion in PMMA (1% nanotubes by mass) obtained by nanoprecipitation, in one embodiment of this invention.

FIG. 7 is a photograph obtained by transmission electron microscopy of a carbon nanotube dispersion in PMMA (1% nanotubes by mass) obtained by nanoprecipitation, in one embodiment of this invention, after annealing at 120° C. for 30 minutes.

FIG. 8 is a photograph obtained from scanning electron microscopy of a carbon nanotube dispersion in PMMA (1% nanotubes by mass) obtained by nanoprecipitation, in one embodiment of this invention. After centrifugation, the PMMA nanocomposite and the carbon nanotubes were recovered and heated to a temperature above the glass transition temperature of the PMMA to melt the PMMA particles. Microscopic observation of the sample showed a good dispersion of the carbon nanotubes.

### DESCRIPTION OF THE INVENTION

This invention relates to a method for preparing submicronic particles of a thermoplastic polymer encapsulating nanoparticles, said submicronic particles being obtained by nanoprecipitation. The nanoparticles are first dispersed in a non-solvent of the polymer. A polymer solution is then mixed into this carbon nanotube dispersion so they can be encapsulated by the submicronic polymer particles; these are controlled by various factors such as the initial composition of the polymer solution, the solvent:non-solvent ratios in the final mixture, the pH and the temperature. In one embodiment of this invention, the nanoparticles are carbon nanotubes.

The encapsulated carbon nanotube dispersion is metastable and the nanocomposite material is recovered as a very fine powder in which the nanofiller is in a non-agglomerated state and well dispersed. Nanocomposite material manufactured in this way can be reprocessed using traditional methods such as extrusion.

The nanoprecipitation method of this invention has many advantages when compared to other existing methods (for example “latex technology” or “coagulation”), such as the high quality carbon nanotube dispersion,

the speed and ease of implementation and the fact that it does not require special mixing equipment.

In one embodiment of this invention, the nanoprecipitation takes place under strict thermodynamic and kinetic conditions which require:

(i) complete or partial miscibility of the solvents (i.e. solvent 1 with solvent 2);

(ii) total solubility of the polymer in solvent 2 at the desired concentrations;

(iii) insolubility of the polymer in the mixture of solvent 1 with solvent 2 in the final proportions.

Non-conformity of one or more of the conditions resulting in a demixed polymer or the polymer remains soluble and is not part of the nanoprecipitation. To facilitate solvent selection, it is useful to use solubility parameters such as Hansen solubility parameters and the corresponding solubility graph. Using this type of solubility graph, it is possible to define the solubility of a polymer in solvent 2 and its insolubility in a mixture of the final proportions of solvents 1 and 2 in order to meet conditions (ii) and (iii).

In one embodiment of this invention, the carbon nanotubes are dispersed in one of the solvents, preferably the solvent which does not contain the polymer (solvent 1). The dispersion of carbon nanotubes can be performed using any method known to those skilled in the art. In one embodiment of this invention, the dispersion is done using ultrasound

and/or functionalization or carbon nanotubes by chemical or physical interactions (i.e. by covalent bonding). The use of ultrasound allows the carbon nanotubes to be isolated by disagglomeration of the aggregates and the faggots of carbon nanotubes. Functionalization of carbon nanotubes allows the modification of their apparent chemical nature to make them compatible with organic matrices. The ease and quality of the dispersion of carbon nanotubes in solvent 1 can be one of the selection criteria for this solvent as the final quality of the dispersion of the carbon nanotubes in the thermoplastic polymer depends on the quality of the initial carbon nanotube dispersion in the non-solvent for the thermoplastic polymer. In one embodiment of this invention, the respective concentrations of carbon nanotubes in solvent 1 and polymer in solvent 2 are chosen so as to result in the desired nanocomposite material.

Surprisingly, it was observed that under certain conditions, the presence of carbon nanotubes dispersed in solvent 1 allows the manufacture of submicronic spherical particles of thermoplastic polymer encapsulating carbon nanotubes. To manufacture these submicronic spherical particles of thermoplastic polymer encapsulating carbon nanotubes, in addition to the criteria listed above for the nanoprecipitation of thermoplastic polymers, it is preferable that the dispersion of carbon nanotubes is stable in the final solvent mixture. The addition of a very large fraction of polymer solution (thermoplastic polymer in solvent 2) has the consequence that, on the one hand, nanoprecipitation does not occur because the thermoplastic polymer is soluble in the solvent mixture and submicronic spherical particles of thermoplastic polymer are not obtained an, on the other hand, the dispersion of carbon nanotubes is destabilized. The addition of a significant fraction of polymer solution (thermoplastic polymer in solvent 2) results in a system composed of insoluble thermoplastic polymer and a destabilized dispersion of carbon nanotubes. In addition to the two areas described above, the pouring a smaller fraction of thermoplastic polymer solution whose concentration is low yields submicronic spherical particles of thermoplastic polymer

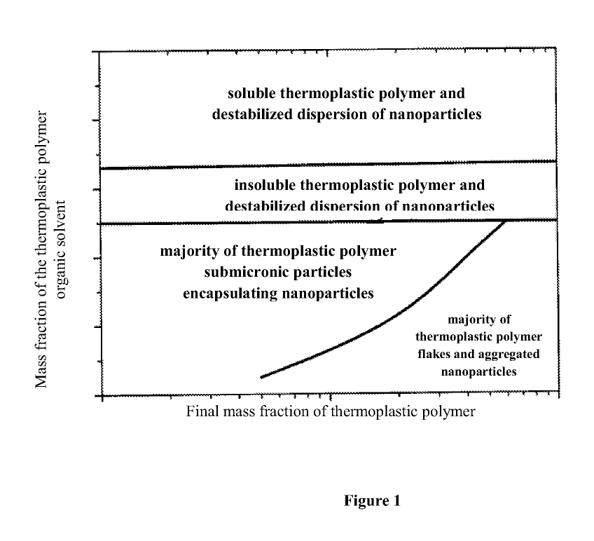

encapsulating carbon nanotubes. Adding an identical fraction of thermoplastic polymer solution as in the previous case, but of higher concentration, results in mixtures composed of thermoplastic polymer flakes, aggregates of nanoparticles and a small amount of submicronic spherical particles of thermoplastic polymer encapsulating carbon nanotubes. These differences are shown in FIG. 1. It appears that obtaining a product which consists mainly of submicronic spherical particles of thermoplastic polymer encapsulating carbon nanotubes cannot be done without a good knowledge of the process parameters described within this invention.

Each solvent system has its own phase graph. These graphs are constructed by making several test mixtures by varying the initial polymer concentration in the solvent 2 and the final ratio [m_{solvent 1}/(m_{solvent 1}+m_{solvent 2})]. For each test, the resulting system is characterized by visual observation. In addition to this visual observation, the polymer particles obtained by nanoprecipitation can be characterized by various techniques known to those skilled in the art, such as measurement of particle size by light scattering or electron microscopy to establish particle size and distribution of particle size.

When carbon nanotubes are initially dispersed in water, the pH strongly influences the final characteristics of the nanocomposite material (i.e., the submicronic particles of thermoplastic polymer encapsulating the carbon nanotubes). On one hand, the increase in pH reduces the average distribution of particle size. On the other hand, if the nanoprecipitation is accompanied by demixing, it was observed that increasing the pH stabilizes the spherical submicronic particles that were formed. In one embodiment of this invention, the pH of the aqueous dispersion is between 7.0 and 14.0. In another embodiment of this invention, the pH of the aqueous dispersion is between 9.0 and 12.0.

In one embodiment of this invention, the manufacture of nanocomposite material requires the dispersion of carbon nanotubes in a first solvent (solvent 1). Dispersion methods are known to those skilled in the art. In one embodiment of this invention, the carbon nanotube concentration is between 0.001 and 5% by mass. In one embodiment of this invention, the carbon nanotube concentration is between 0.1 and 2% by mass. Solvent 1 is typically chosen from non-solvents for thermoplastic polymers.

In one embodiment of this invention, solvent 1 is water. In one embodiment of this invention, the pH of the aqueous dispersion adjusted to between 7.0 and 14.0. In one embodiment of this invention, the pH of the aqueous dispersion adjusted to between 9.0 and 13.0.

The thermoplastic polymer is dissolved into a second solvent (solvent 2). In one embodiment of this invention, the thermoplastic polymer concentration in the solvent is between 0.001 and 10% by mass. In another embodiment of this invention, the thermoplastic polymer concentration in the solvent is between 0.01 and 2% by mass. In another embodiment of this invention, the thermoplastic polymer concentration in the solvent is between 0.01 and 0.2% by mass.

In one embodiment of this invention, the thermoplastic polymer—defined by a glass transition temperature above 15° C.—is chosen from the group of vinyl polymers such as polyacrylate, polymethacrylate, polymethyl methacrylate, polyethylacrylate, polyacrylamide, polyacrylonitrile or polystyrene, polyethylene, polypropylene, fluoropolymer, chloro polymer, and from polymers such as polycarbonate, polyester, polyamide, polyether ketone, polyether sulfone, polyether, polyphosphate, polythiophene and their derivatives, or one of their copolymer derivatives.

A phase is added to the second without stirring to cause nanoprecipitation and to obtain the submicronic spherical particles encapsulating the carbon nanotubes. The speed of transition from one phase to another can be slow or fast. In one embodiment of this invention, the transfer speed is fast because it appears that the dispersion of submicronic spherical polymer particles encapsulating nanoparticles are more stable in the case of fast pouring.

The volume of the phase containing the polymer is between 1 and 80% of the final volume (i.e., total volume of the phase containing the polymer and the phase containing the nanoparticles). In one embodiment of this invention, the volume of the phase containing the polymer is between 20 and 70% of the final volume. In one embodiment of this invention, solvent 1 (containing carbon nanotubes) is poured into solvent 2 (containing the polymer).

In one embodiment of this invention, the evaporation of the solvent 2 (first solvent of the thermoplastic polymer) of the final system after nanoprecipitation, provided an increase in system stability, which changed from several hours to several days.

In one embodiment of this invention, the emulsion stability obtained by nanoprecipitation is long enough to allow a reaction, such as condensation, addition, substitution, oxidation reaction, reduction reaction, cycloaddition, radical reaction or photochemical reaction between the nanoparticles and the thermoplastic polymer leading to a strong interface between the nanofiller and the nanocomposite matrix—a key parameter to obtain high-performance nanocomposite materials.

The initial quality of the carbon nanotube dispersion in the solvent has a direct impact on the quality of the carbon nanotube dispersion in the final nanocomposite material. Nanoprecipitation, according to an embodiment of this invention, has the effect of “freezing” the initial dispersion of carbon nanotubes by encapsulating them in the thermoplastic polymer. This is of great interest because it is known to those skilled in the art that it is easier to finely disperse carbon nanotubes in a solvent than in a thermoplastic polymer.

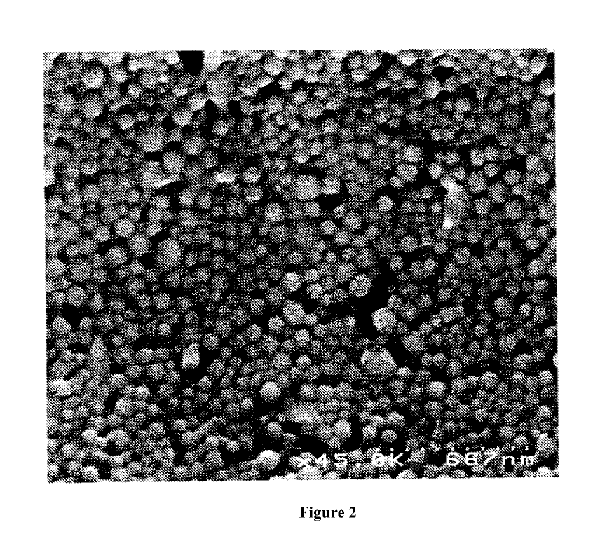

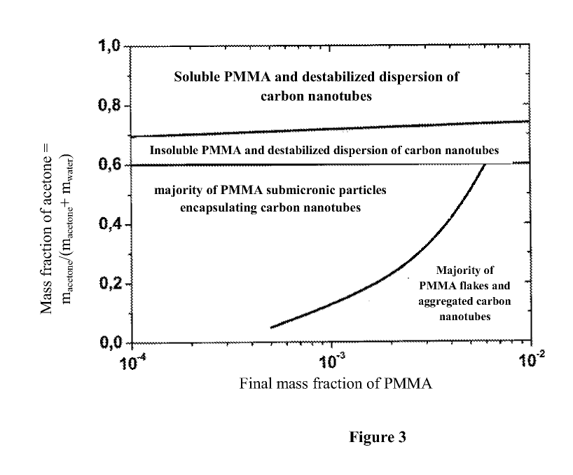

The inventors observed that the solution adopted for the dispersion of carbon nanotubes in a solvent can influence the phase graph. This can happen if the carbon nanotubes are functionalized by physical interactions. For example, the inventors experimentally derived phase graphs from the nanoprecipitation of carbon nanotubes and PMMA, firstly with stabilization of carbon nanotubes in a solvent using sodium cholate, and secondly with stabilization of carbon nanotubes in a solvent using salt of sodium dodecylbenzenesulfonate (FIGS. 2 and 3). It appears that the window for obtaining submicronic particles of thermoplastic polymer encapsulating carbon nanotubes is larger when carbon nanotubes are initially stabilized by sodium cholate than when they are initially stabilized by sodium dodecylbenzenesulfonate.

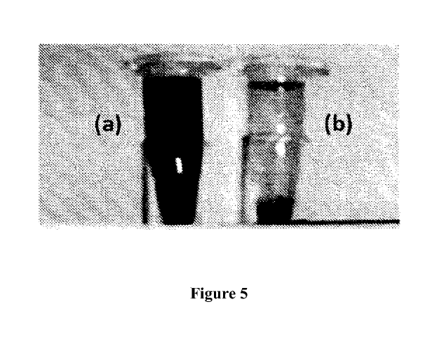

The nanocomposite material can be recovered by means known to those skilled in the art to destabilize an emulsion, such as ultracentrifugation (FIG. 5).

The quality of the final dispersion of carbon nanotubes in the nanocomposite material can be assessed by means known to those skilled in the art,

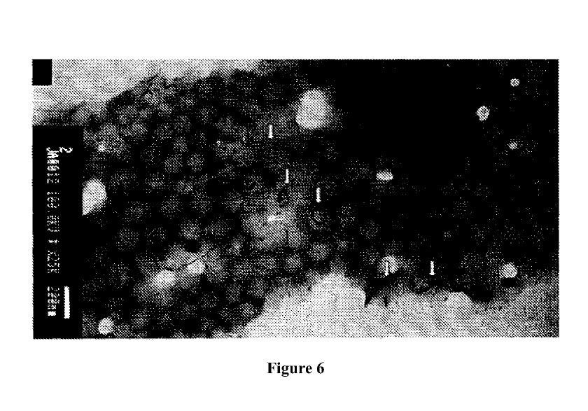

such as electron microscopy (e.g. transmission electron microscopy (TEM) (FIG. 6).

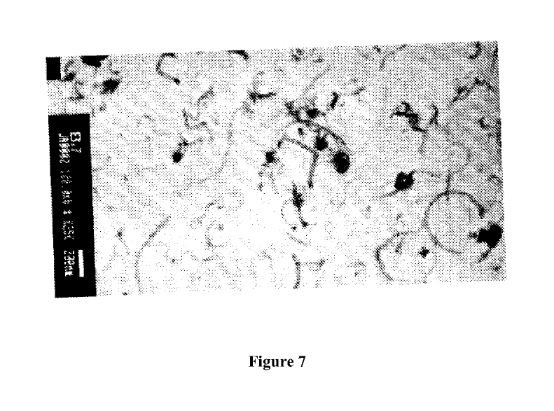

Nanocomposite materials of this invention can be processed without significant degradation of the quality of the dispersion of carbon nanotubes. For example, according to one embodiment of this invention, a nanocomposite annealed at 120° C. for 30 minutes shows a dispersion quality equivalent to that obtained before annealing (FIG. 7). This property allows the use of nanocomposite materials of this invention as a “masterbatch” to be diluted in different matrices by traditional means of shaping such as extrusion.

The method of the invention will be better understood from the examples presented below; however, these do not limit the scope of the invention.

The following examples have been performed using the phase graph as shown in FIG. 1.

### Example 1

200 mg of PMMA (15,000 g·mol⁻¹) dissolved in 125 ml of acetone.

To create spontaneous emulsification, the proportions of each solution were chosen to fall in the ouzo region (m_{acetone}/(m_{acetone}+m_{water})=0.5; the final mass fraction of PMMA=0.001). Experimentally, 6.25 ml of the PMMA solution is quickly poured into 5 ml of water to obtain a final concentration of submicronic PMMA spherical particles of 0.1% by mass. A metastable emulsion in the form of a turbid white mixture was obtained. Microscopic observations confirmed a narrow distribution of the particle size

around 100 nm. These results were confirmed by measurements of light scattering. The emulsion was stable for at least 15 hours.

### Example 2

200 mg of PMMA (15,000 g·mol⁻¹) dissolved in 125 ml of acetone.

2 mg of carbon nanotubes were added to the previous solution (Example 1) to obtain a concentration of carbon nanotubes compared to PMMA of 1% by mass. The mixture of carbon nanotubes/PMMA in acetone was intensively sonicated to obtain a homogeneous dispersion of carbon nanotubes.

To create spontaneous emulsification, the proportions of each solution were chosen to fall in the ouzo region (m_{acetone}/(m_{acetone}+m_{water})=0.5; the final mass fraction of PMMA=0.001). Experimentally, 6.25 ml of the PMMA/carbon nanotube solution is quickly poured into 5 ml of water to obtain a final concentration of submicronic PMMA spherical particles of 0.1% by mass. Spontaneous demixing was observed leading to PMMA flakes onto which the carbon nanotubes aggregated. Visually, the solution appears heterogeneous and this is confirmed by microscopic observations.

### Example 3

200 mg of PMMA (15,000 g·mol⁻¹) dissolved in 125 ml of acetone.

An aqueous dispersion of carbon nanotubes is achieved by intensive sonication of 2 mg of carbon nanotubes in 100 ml of water;

a final concentration of 0.002% by mass is obtained. The pH of the aqueous phase was adjusted to 10 using sodium hydroxide.

To create spontaneous emulsification, the proportions of each solution were chosen to fall in the ouzo region (m_{acetone}/(m_{acetone}+m_{water})=0.5; the final mass fraction of PMMA=0.001). Experimentally, 6.25 ml of the PMMA solution is quickly poured into 5 ml of aqueous dispersion to obtain a final concentration of submicronic PMMA spherical particles of 0.1% by mass. A metastable emulsion is partially achieved. Although part of the mixture was in the form of a light gray turbid mixture, flakes of PMMA onto which the carbon nanotubes aggregated are also observed. Microscopic observations confirm the heterogeneous mixture.

### Example 4

200 mg of PMMA (15,000 g·mol⁻¹) dissolved in 125 ml of acetone.

An aqueous dispersion of carbon nanotubes is achieved by intensive sonication of 2 mg of carbon nanotubes in 100 ml of water in the presence of 4 mg of sodium cholate; a final concentration of 0.002% by mass is obtained. The pH of the aqueous phase was adjusted to 10 using sodium hydroxide.

To create spontaneous emulsification, the proportions of each solution were chosen to fall in the ouzo region (m_{acetone}/(m_{acetone}+m_{water})=0.5; the final mass fraction of PMMA=0.001). Experimentally, 6.25 ml of the PMMA solution is quickly poured into 5 ml of aqueous dispersion of carbon nanotubes to obtain a final concentration of submicronic PMMA spherical particles of 0.1% by mass. A metastable emulsion in the form of a turbid light gray mixture is obtained. Microscopic observations

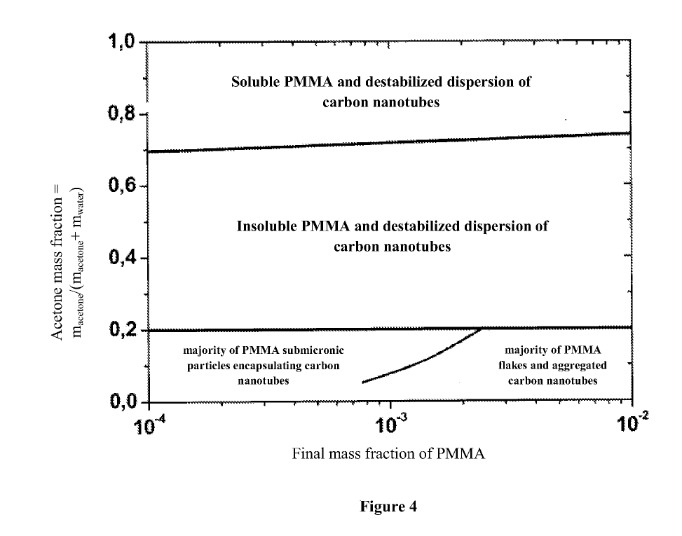

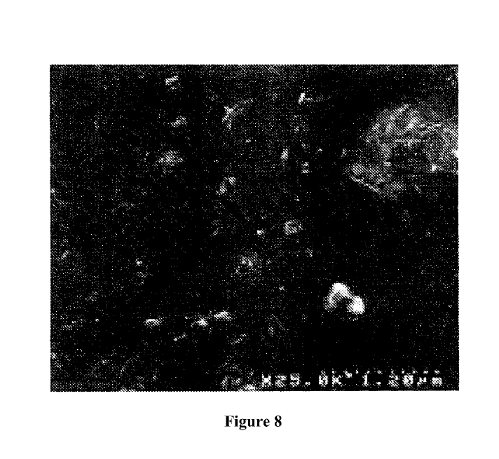

confirm a narrow distribution of PMMA spherical particle size centered around 100 nm (FIG. 4). The carbon nanotubes are not visible via scanning electron microscopy and this tends to confirm their encapsulation by PMMA. The observed particle size is confirmed by measurements of light scattering. The resulting product is a nanocomposite of PMMA and carbon nanotubes up to 1% by mass. The emulsion was stable for at least 15 hours. After centrifugation, the PMMA nanocomposite and the carbon nanotubes were recovered and heated to a temperature above the glass transition temperature of the PMMA to melt the PMMA particles. Microscopic observation of the sample shows a good dispersion of the carbon nanotubes (FIG. 8).

### Example 5

200 mg of PMMA (15,000 g·mol⁻¹) dissolved in 125 ml of acetone.

An aqueous dispersion of carbon nanotubes is achieved by intensive sonication of 2 mg of carbon nanotubes in 100 ml of water in the presence of 4 mg of sodium dodecylbenzenesulfonate; a final concentration of 0.002% by mass is obtained. The pH of the aqueous phase was adjusted to 10 using sodium hydroxide.

The proportions of each phase were chosen to achieve the ratio m_{acetone}/(m_{acetone}+m_{water})=0.5 and a final mass fraction of PMMA=0.001). Experimentally, 6.25 ml of the PMMA solution is quickly poured into 5 ml of aqueous dispersion to obtain a final concentration of submicronic PMMA spherical particles of 0.01% by mass. Spontaneous demixing was observed leading to submicronic PMMA particles and PMMA flakes onto which the carbon nanotubes aggregated. Visually, the solution appears heterogeneous and this is confirmed by microscopic observations.

### Example 6

1 g of PMMA (15,000 g·mol⁻¹) dissolved in 125 ml of acetone.

An aqueous dispersion of carbon nanotubes is achieved by intensive sonication of 0.9 mg of carbon nanotubes in 100 ml of water in the presence of 1.8 mg of sodium dodecylbenzenesulfonate; a final concentration of 0.0009% by mass is obtained. The pH of the aqueous phase was adjusted to 10 using sodium hydroxide.

To create spontaneous emulsification, the proportions of each solution were chosen to fall in the ouzo region (m_{acetone}/(m_{acetone}+m_{water})=0.1; the final mass fraction of PMMA=0.001). Experimentally, 1.25 ml of the PMMA solution is quickly poured into 9 ml of aqueous dispersion of carbon nanotubes to obtain a final concentration of submicronic PMMA spherical particles of 0.1% by mass. A metastable emulsion in the form of a turbid light gray mixture is obtained. The carbon nanotubes are not visible via scanning electron microscopy and this tends to confirm their encapsulation by PMMA. The resulting product is a nanocomposite of PMMA and carbon nanotubes up to 1% by mass.

### Example 7

111 mg of PMMA (15,000 g·mol⁻¹) dissolved in 125 ml of acetone.

An aqueous dispersion of carbon nanotubes is achieved by intensive sonication of 10 mg of carbon nanotubes in 100 ml of water in the presence of 20 mg of sodium cholate; a final concentration of 0.01% by mass is obtained. The pH of the aqueous phase was adjusted to 10 using sodium hydroxide.

The proportions of each phase were chosen to achieve the ratio m_{acetone}/(m_{acetone}+m_{water})=0.9 and a final mass fraction of PMMA=0.001. Experimentally, 11.25 ml of the PMMA solution is quickly poured into 1 ml of aqueous dispersion to obtain a final concentration of submicronic PMMA spherical particles of 0.0% by mass. PMMA remained soluble and the formation of submicronic spherical particles was not observed. Moreover, the dispersion of carbon nanotubes was destabilized.

### Example 9

200 mg of PMMA (15,000 g·mol⁻¹) dissolved in 125 ml of acetone.

An aqueous dispersion of carbon nanotubes is achieved by intensive sonication of 2 mg of carbon nanotubes in 100 ml of water in the presence of 4 mg of sodium cholate; a final concentration of 0.002% by mass is obtained. The pH of the aqueous phase was adjusted to 10 using sodium hydroxide.

To create spontaneous emulsification, the proportions of each solution were chosen to fall in the ouzo region (m_{acetone}/(m_{acetone}+m_{water})=0.5; the final mass fraction of PMMA=0.001). Experimentally, 5.0 ml of aqueous dispersion of carbon nanotubes is quickly poured into 6.25 ml of the PMMA solution to obtain a final concentration of submicronic PMMA spherical particles of 0.1% by mass. A metastable emulsion in the form of a turbid light gray mixture is obtained. Microscopic observations confirm a narrow distribution of PMMA spherical particle size centered around 100 nm. The observed particle size is confirmed by measurements of light scattering. The resulting product is a nanocomposite of PMMA and carbon nanotubes up to 1% by mass. The emulsion was stable for at least 15 hours.

### Example 10

200 mg of PMMA (15,000 g·mol⁻¹) dissolved in 125 ml of acetone.

An aqueous dispersion of carbon nanotubes is achieved by intensive sonication of 4 mg of carbon nanotubes in 100 ml of water in the presence of 12 mg of sodium cholate; a final concentration of 0.004% by mass is obtained. The pH of the aqueous phase was adjusted to 10 using sodium hydroxide.

To create spontaneous emulsification, the proportions of each solution were chosen to fall in the ouzo region (m_{acetone}/(m_{acetone}+m_{water})=0.5; the final PMMA mass fraction=0.001). Experimentally, 6.25 ml of the PMMA solution is quickly poured into 5 ml of aqueous dispersion of carbon nanotubes to obtain a final concentration of submicronic PMMA spherical particles of 0.1% by mass. A metastable emulsion in the form of a turbid light gray mixture is obtained. Microscopic observations confirm a narrow distribution of PMMA spherical particle size centered around 100 nm. The carbon nanotubes are not visible via scanning electron microscopy and this tends to confirm their encapsulation by PMMA. The observed particle size is confirmed by measurements of light scattering. The resulting product is a nanocomposite of PMMA and carbon nanotubes up to 2% by mass.

### Example 11

200 mg of PMMA (15,000 g·mol⁻¹) dissolved in 125 ml of acetone.

An aqueous dispersion of carbon nanotubes is achieved by intensive sonication of 2 mg of carbon nanotubes in 100 ml of water in the presence of 4 mg of sodium cholate; a final concentration of 0.002% by mass is obtained. The pH of the aqueous phase was adjusted to 10 using sodium hydroxide.

The proportions of each phase were chosen to achieve the ratio m_{acetone}/(m_{acetone}+m_{water})=0.5 and a final mass fraction of PMMA=0.001. Experimentally, 6.25 ml of the PMMA solution was added drop by drop to 5 ml of aqueous dispersion of carbon nanotubes to obtain a final concentration of submicronic PMMA spherical particles of 0.1% by mass. Demixing was observed leading to PMMA flakes onto which the carbon nanotubes aggregated. Visually, the solution appears heterogeneous and this is confirmed by microscopic observations. A similar experiment while stirring the aqueous dispersion of carbon nanotubes during the addition of PMMA solution gave the same result.

### Example 12

200 mg of PMMA (15,000 g·mol⁻¹) dissolved in 125 ml of acetone.

A dispersion of carbon nanotubes is achieved by intensive sonication of 2 mg of carbon nanotubes in 127 ml of ethanol; a final concentration of 0.002% by mass is obtained.

To create spontaneous emulsification, the proportions of each solution were chosen to fall in the ouzo region (m_{acetone}/(m_{acetone}+m_{water})=0.5; the final mass fraction of PMMA=0.001). Experimentally, 6.25 ml of the PMMA solution is quickly poured into 6.3 ml of carbon nanotube dispersion in ethanol to obtain a final concentration of

submicronic PMMA spherical particles of 0.1% by mass. A metastable emulsion in the form of a turbid light gray mixture is obtained. Microscopic observations confirm a distribution of PMMA spherical particle size centered around 500 nm. However, scanning electron microscopy shows that the carbon nanotubes were not as efficiently dispersed as in the case of a system where the PMMA solution is poured into an aqueous phase. This could be partly attributed to the fact that acetone is more miscible with water than with ethanol. The resulting product is a nanocomposite of PMMA and carbon nanotubes up to 1% by mass.

### Example 13

200 mg of PMMA (15,000 g·mol⁻¹) dissolved in 125 ml of acetone.

An aqueous dispersion of carbon nanotubes is achieved by intensive sonication of 2 mg of carbon nanotubes in 100 ml of water in the presence of 4 mg of sodium cholate; a final concentration of 0.002% by mass is obtained. The pH of the aqueous phase was adjusted to 9 using sodium hydroxide.

To create spontaneous emulsification, the proportions of each solution were chosen to fall in the ouzo region (m_{acetone}/(m_{acetone}+m_{water})=0.5; the final mass fraction of PMMA=0.001). Experimentally, 6.25 ml of the PMMA solution is quickly poured into 5 ml of aqueous dispersion of carbon nanotubes to obtain a final concentration of submicronic PMMA spherical particles of 0.1% by mass. A metastable emulsion in the form of a turbid light gray mixture is obtained. Microscopic observations confirm a narrow distribution of PMMA spherical particle size centered around 300 nm. The resulting product is a nanocomposite of PMMA and carbon nanotubes up to 1% by mass. The emulsion was stable for at least 15 hours.

1. Method for preparing submicronic particles of a polymer encapsulating nanoparticles, said particles being obtained by nanoprecipitation; this process involves;
a) dispersion of nanoparticles in a first solvent, said solvent being a non-solvent for the polymer;
b) dissolution of the polymer into a second solvent; and
c) inducing nanoprecipitation by pouring the polymer solution into the nanoparticle dispersion.

2. Method according to claim 1, characterized in that the first and second solvent are at least partially miscible and the polymer is insoluble in a mixture of the first and second solvent in the final proportions.

3. Method according to claim 2, characterized in that the dispersion is an aqueous dispersion.

4. Method according to claim 2, characterized in that the nanofiller is in a non-agglomerated state.

5. Method according to claim 2, characterized in that the polymer is a thermoplastic polymer.

6. Method according to claim 2, characterized in that the nanoparticles are carbon nanotubes.

7. Method according to claim 3, characterized in that pH of the aqueous dispersion varies between 7.0 and 14.0.

8. Method according to claim 4, characterized in that pH of the aqueous dispersion varies between 9.0 and 12.0.

9. Method according to claim 2, characterized in that the concentration of nanoparticles is between 0.001 and 5% by mass.

10. Method according to claim 9, characterized in that the concentration of nanoparticles is between 0.1 and 2% by mass.

11. Method according to claim 1, characterized in that the concentration of polymer is between 0.001 and 10% by mass.

12. Method according to claim 11, characterized in that the concentration of polymer is between 0.01 and 2% by mass.

13. Method according to claim 12, characterized in that the concentration of polymer is between 0.001 and 0.2% by mass.

14. Method according to claim 5, characterized in that the thermoplastic polymer has a glass transition temperature above 15° C.

15. Method according to claim 14, characterized in that the thermoplastic polymer is chosen from the group of vinyl polymers such as polyacrylate, polymethacrylate, polymethyl methacrylate, polyethylacrylate, polyacrylamide, polyacrylonitrile or polystyrene, polyethylene, polypropylene, fluoropolymer, chloro polymer, and from polymers such as polycarbonate, polyester, polyamide, polyether ketone, polyether sulfone, polyether, polyphosphate, polythiophene and their derivatives, or one of their copolymer derivatives.

16. Method according to claim 2, characterized in that volume of the second solvent is between 1 and 80% of the total volume when the first solvent is mixed with the second solvent.

17. Method according to claim 16, characterized in that volume of the second solvent is between 20 and 70% of the total volume when the first solvent is mixed with the second solvent.

18. Method for preparing submicronic particles of a polymer encapsulating nanoparticles, said particles being obtained by nanoprecipitation; this process involves;
a) dispersion of nanoparticles into a first solvent, this first solvent being a non-solvent for the polymer;
b) dissolution of the polymer into a second solvent; and
c) inducing nanoprecipitation by pouring the nanoparticle dispersion into the polymer solution.

19. Method according to claim 18, characterized in that the first and second solvent are at least partially miscible and the polymer is insoluble in a mixture of the first and the second solvent in the final proportions.

20. Method according to claim 19, characterized in that the dispersion is an aqueous dispersion.

21. Method according to claim 19, characterized in that the nanofiller is in a non-agglomerated state.

22. Method according to claim 19, characterized in that the polymer is a thermoplastic polymer.

23. Method according to claim 19, characterized in that the nanoparticles are carbon nanotubes.

24. Method according to claim 20, characterized in that pH of the aqueous dispersion varies between 7.0 and 14.0.

25. Method according to claim 24, characterized in that pH of the aqueous dispersion varies between 9.0 and 12.0.

26. Method according to claim 19, characterized in that the concentration of nanoparticles is between 0.001 and 5% by mass.

27. Method according to claim 26, characterized in that the concentration of nanoparticles is between 0.1 and 2% by mass.

28. Method according to claim 18, characterized in that the concentration of polymer is between 0.001 and 10% by mass.

29. Method according to claim 28, characterized in that the concentration of polymer is between 0.01 and 2% by mass.

30. Method according to claim 29, characterized in that the concentration of polymer is between 0.001 and 0.2% by mass.

31. Method according to claim 22, characterized in that the thermoplastic polymer has a glass transition temperature above 15° C.

32. Method according to claim 31, characterized in that the thermoplastic polymer is chosen from the group of vinyl polymers such as polyacrylate, polymethacrylate, polymethyl methacrylate, polyethylacrylate, polyacrylamide, polyacrylonitrile or polystyrene, polyethylene, polypropylene, fluoropolymer, chloro polymer, and from polymers such as polycarbonate, polyester, polyamide, polyether ketone, polyether sulfone, polyether, polyphosphate, polythiophene and their derivatives, or one of their copolymer derivatives.

33. Method according to claim 19, characterized in that volume of the second solvent is between 1 and 80% of the total volume when the first solvent is mixed with the second solvent.

34. Method according to claim 33, characterized in that volume of the second solvent is between 20 and 70% of the total volume when the first solvent is mixed with the second solvent.

35. A submicronic polymer particle encapsulating nanoparticles which could be obtained from the method of claim 1 or 18, characterized in that the nanofiller is in a non-agglomerated state.

36. A submicronic particle according to claim 35, characterized in that the polymer is a thermoplastic polymer.

37. A submicronic particle according to claim 36, characterized in that the thermoplastic polymer has a glass transition temperature above 15° C.

38. Method according to claim 37, characterized in that the thermoplastic polymer is chosen from the group of vinyl polymers such as polyacrylate, polymethacrylate, polymethyl methacrylate, polyethylacrylate, polyacrylamide, polyacrylonitrile or polystyrene, polyethylene, polypropylene, fluoropolymer, chloro polymer, and from polymers such as polycarbonate, polyester, polyamide, polyether ketone, polyether sulfone, polyether, polyphosphate, polythiophene and their derivatives, or one of their copolymer derivatives.

39. A submicronic particle according to claim 35, characterized in that the nanoparticles are carbon nanotubes.

40. Use of submicron particles according to claim 35, for preparing materials reinforced by nanoparticles.

41. Use according to claim 40, said reinforced material including an epoxy resin.
